(19) United States
(12) Patent Application Publication
(10) Pub. No.: US 2019/0327950 A1
(43) Pub. Date: Oct. 31, 2019

(54) ANIMAL SHOE, IN PARTICULAR AN ORTHOPEDIC SHOE FOR ANIMAL FEET FOR THE RELIEF OF LAME CLOVEN-HOOFED ANIMALS, AND SHOE BASE AND KIT FOR SUCH AN ANIMAL SHOE

(71) Applicant: Jan-Michael STEILS, Wolnzach (DE)

(72) Inventor: Jan-Michael STEILS, Wolnzach (DE)

(21) Appl. No.: 16/471,743

(22) PCT Filed: Dec. 19, 2017
(86) PCT No.: PCT/EP2017/083564

§ 371 Date: Jun. 20, 2019

(30) Foreign Application Priority Data
Dec. 20, 2016 (DE) 10 2016 225 657.2

(51) Int. Cl. A01L 9/00

(52) U.S. Cl. CPC A01L 9/00

(57) ABSTRACT

The invention relates to an animal shoe (1), in particular an orthopedic shoe for animal feet (2) for the relief of lame even-toed ungulates (3), as well as to a shoe base (11) and to a kit for such an animal shoe (1). In order to relieve the injured region of lame animals, such as even-toed ungulates, inexpensively and safely, quickly and easily even by inexperienced staff, the animal shoe (1) according to the invention comprises a shoe base (11) having an outsole (13) and an insole (14) that is disposed opposite to the outsole (13), and a fastening shaft (12) which can be customized accurately to the animal foot (2) and for affixing to the animal foot (2). The shoe base (11) according to the invention comprises an outsole (13) which is formed from closed-cell foam (18) and an insole (14) which is disposed opposite to the outsole (13). The kit according to the invention comprises the shoe base (11) according to the invention and a fastening shaft (12) which can be customized accurately to the animal foot (2) and comprises a fastening portion (15) for affixing to the animal foot (2) and an attachment region (16) for the connection to the shoe base (11).

The invention relates to an animal shoe, in particular an orthopedic shoe for animal feet for the relief of lame even-toed ungulates, such as cattle.

The present invention further relates to a shoe base for an animal shoe, in particular for an orthopedic shoe for animal feet for the relief of lame even-toed ungulates and a kit for such an animal shoe comprising this shoe base.

The indoor housing of animals, the nutrition and the breeding programs (breeding objectives) of domestic and farm animals often lead to the animals developing disorders at their (skeletal system) limbs and feet, in the case of even-toed ungulates, for example, their claws. The result is often lameness, which is understood to mean impairing the gait pattern of animals.

Lameness not only reduces animal wellbeing, but also reduces the economic viability of the animals. For example, lame dairy cows have a lower milk yield. The result of lameness can even be an early departure for slaughtering and therefore a reduced useful life expectancy. This is uneconomical because the animals then depart from the operations and therefore from the milk production. In addition, lame animals cause increased costs for medication and veterinary costs, as well as increased working hours for their care. Furthermore, claw disorders are very painful and reduce animal wellbeing.

The causes of lameness are to be found in a disorder of the distal limbs of the animals. For even-toed ungulates and odd-toed ungulates, these disorders are referred to as claw disorders.

Lameness as a result of claw disorders has a prevalence of 15-35% on average worldwide. The cause of the clinical condition of lameness is infectious and non-infectious claw disorders. Non-infectious claw disorders arise, for example, from overburdening and inadequate feeding. In addition, animal husbandry—in common dairy stables, the animals stand and run on hard-surfaced or slatted floors—causes these disorders. Infectious claw disorders are usually caused by inadequate hygiene in the stables. Infectious and non-infectious claw disorders typically occur together.

The time of several hours per day that the cattle spends lying down is essential for claw health, and the animals must be able to move freely and long periods standing at the feed table or in front of the milking parlor must be avoided. The background of these recommendations is the blood supply to the distal limbs, which differs greatly depending on the load situation. When lying down and thus in an unloaded position, the blood can circulate freely in the capillaries of the distal limbs of the cow. The exchange of arterial and venous blood ensures the removal of cellular metabolic end products. If this removal stagnates, then damage to the cellular matrix and, depending on the extent, severe consequences arise. During the movement process when running, the ball or bulb of the claw not only assumes a dampening function due to fatty tissue, but also the function of distributing blood. When the claw is loaded, the blood in the capillaries is pressed onward by the resulting pressure in the digital cushion; when it is unloaded, arterial blood flows. Loading and unloading transports the blood. The digital cushion is therefore essential for the health of peripheral extremities. When standing, deteriorated blood transport arises due to a constant load, long time standing on hard surfaces is therefore detrimental to claw health.

When a claw disorder rises, then typically only one of the claws of a limb is affected. Slightly infectious foot or claw disorders are treated with an antibiotic spray. Disorders of a medium and higher degree are typically systemically treated with antibiotics. For this purpose, a protective bandage can be applied which is protective against contamination and water using hoof tar or tape. In particular with even-toed ungulates, the ailing claw is removed from the sequence of motion in that the healthy claw is provided with a claw block. To accelerate the healing process and to unload the sick claw, a so-called claw block is glued to the healthy claw. As a result, the sick claw is raised and excluded from the movement/load.

Claw blocks, as they are known for example from DE 100 33 822 A1, raise the healthy claw and thereby relieve the sick claw. The relief reduces pain and causes faster wound healing. Known block systems consist of a wooden or plastic block which is glued to the underside of the claw. The existing systems are disadvantageous for a variety of reasons. They are difficult to handle. Inexperienced users cannot attach them on their own, since standard-compliant claw trimming must first be performed. This requires a veterinarian or claw caretaker. Claw blocks made of wood are hard and do not support the physiological sequence of motion of the claws. With known claw blocks, unphysiological foot placement arises resulting in serious changes in the load pressure on the claw. A claw block also impairs the function of the digital cushion and eliminates the natural damping properties of the ball, since the ball must be excluded from the adhesive during the attachment. In the worst case, this leads to the healthy claw being overloaded and damaged. Glued blocks must be fabricated to fit accurately, otherwise they cause pressure points or adversely affect the pressure distribution. One possible consequence of using existing block systems is the healthy claw becoming sick. Although plastic blocks are less hard, they still have to be glued on. The adhesives used are harmful to health and their use poses a risk to humans and animals. There is a risk that microparticles can enter the food chain because these substances are applied to an animal that delivers food. Residual amounts of the adhesive are to be disposed of as hazardous waste. In addition, the adhesives must first cure, so that existing claw block systems are time-consuming and labor-intensive. Finally, glued blocks can be removed only with great effort.

In view of these drawbacks, there is a need for a better solution for the relief of lame animals such as even-toed ungulates, which is inexpensive and non-hazardous, and which can be implemented quickly and easily, even by untrained staff.

The present invention satisfies this object with an animal shoe, in particular an orthopedic shoe for animal feet for the relief of lame even-toed ungulates, comprising a shoe base which has an outsole and an insole that is disposed opposite to the outsole, and a fastening shaft which can be customized accurately to the animal foot and for affixing to the animal foot.

Dispensing with an adhesive component, by using a fastening shaft that can be fitted accurately to the animal foot, improves user-friendliness and reduces the time required for affixing and donning the animal shoe. An adhesive component is not required. In addition, the animal shoe according to the invention can be quickly and easily removed again from the animal foot, for example, from a claw of a lame even-toed ungulate. In addition, no expertise regarding animal foot health is required for the animal shoe according to the invention. To affix the shoe base to the animal foot, the fastening shaft is slipped over at least part of the animal foot and then affixed. Customized and accurate fit fixation is to be understood such that the fastening shaft adjusts and fits accurately to the animal foot without causing injury to soft tissues against which the fastening shaft abuts, and that the blood circulation in the animal foot is not adversely affected. In an accurately customized attachment, no or at most negligible tensile forces act upon the animal foot, i.e. the center of the claw, so that the horn formation of the claw is not adversely affected, as is the case with elastic compression bandages, bindings, buckles or strap attachments, which when lashed all together exert impact forces towards the center of the claw (i.e. forces influencing the horn growth). Due to the fact that the fastening shaft is customized and adaptable, i.e. changeable in its shape, it can abut in a form-fitting animal-specific manner, regardless of width, height, length of the animal foot.

The animal shoe according to the invention can be further improved by various embodiments that are advantageous on their own and can be combined with each other at random. These embodiments and the advantages associated therewith shall be described below.

The animal shoe can be an orthopedic shoe for relief, i.e. a relief aid for the feet of lame animals. The animal shoe can be, in particular, an orthopedic relief aid for a claw of an ungulate with several toes, for example, an even-toed ungulate, the shoe base of which is disposed on a single toe of the animal foot. The other toes of the ungulate with several toes, or even-toed ungulate, can thereby be raised and do not contact the shoe base.

According to one embodiment, the fastening shaft can be configured as a fastening stocking, fastening sock or a circumferentially completely closed collar. This embodiment facilitates the fixation onto the animal foot. The animal shoe can then be simply slipped over the animal foot like a sock in order to don and affix it.

The fastening shaft can have a fastening portion that can be slipped over the animal foot or a part of the animal foot, for affixing to the animal foot. Disposed opposite the fastening portion, the fastening shaft can have an attachment region for connection to the shoe base.

The fastening shaft can be configured to be affixed to a toe horn. The length of the fastening shaft from its attachment region on the shoe base to the opposite end of the fastening portion can correspond to the size of the toe, e.g. to a claw, for which the animal shoe is designed. As a result, the natural sequence of motion of the animals is impaired as little as possible. The fastening shaft of an animal shoe designed for even-toed ungulates can end in particular at the level of the individual claw and specifically below the dewclaws. Therefore, no attachment of the animal shoe is performed above the dewclaws in this embodiment.

According to one further advantageous embodiment, the fastening shaft consists of shrinkable material. Shrinkable material is understood to mean material that reduces its spatial expansions when activated. The activation can be effected in various ways, for example by a change in temperature, irradiation with light of a certain wavelength or the addition of an activation agent. Well-suited and easy to handle are shrinkable materials that are activated by the action of heat, preferably at temperatures below 80° C., preferably from 50°−75° C., which can be easily achieved by use of conventional hair dryers or hot air blowers. These temperatures are gentle to the skin and the hair. The advantage of shrinkable material is that it can be quickly and easily customized, i.e. can be adapted in an accurately fitting and animal-specific manner to the respective animal foot after it has been slipped over the animal foot. This enables a positive fit of the fastening shaft on the animal foot, without the risk of unwanted tissue injury or the constriction of the blood circulation. The fastening shaft can be configured, for example, as a shrink tube. Such heat shrink tubing is inexpensive to manufacture. It can be easily manufactured in the desired dimensions, which, firstly, allow it to be donned over the animal foot and, secondly, has a sufficient shrinkage ratio to be fitted accurately to the animal foot to the animal foot upon subsequent activation, which affixes the animal shoe to the foot.

The fastening shaft can be made of plastic material, preferably one that is shrinkable, which simplifies its shaping and reduces costs. A plastic material that complies with an ISO standard of the food industry is harmless. For example, polyolefins such as polyethylene and polypropylene, or polyethylene terephthalate, polytetrafluoroethylene, polyvinyl chloride or an elastomer can be used. Rubber or silicone can also be used as material for a shrinkable fastening shaft. In one embodiment, the fastening shaft can be made of recycled plastic material, which is particularly resource and climate-friendly. In an environmentally friendly variant, the fastening shaft can be made of a petrochemically and/or biologically degradable plastic material, such as a cellulose-based plastic material, polylactic acid or other biopolymer.

According to one further embodiment, the fastening shaft can be connected to the shoe base such that it can be handled as one piece, which simplifies handling and also allows untrained staff to quickly and easily learn to don an animal shoe according to the invention. The shoe base of the animal shoe according to the invention can be joined in the attachment region of the fastening shaft to the latter. The connection can be established by any joining method. For example, a connection by way of textile joining, such as sewing, by gluing, welding, vulcanizing or forming is possible. In one embodiment, the fastening shaft and the shoe base can be welded together. The fastening shaft and the shoe base can preferably be connected to each other by way of lamination. Lamination refers to a positive substance-fit thermal joining process without aids.

In one further embodiment, which relates in particular to an animal shoe for even-toed ungulates, the fastening shaft can be configured to have a Y-shape. A Y-shaped configuration is to be understood such that the fastening shaft has a trunk and two arms branching off from the trunk. The trunk of the Y-shaped fastening shaft can form the fastening portion with which the fixation above the claws of even-toed ungulates is effected on the animal leg. Each of the two arms branching off from the trunk serves to receive one of the two claws. As a result, a Y-shaped fastening shaft is ideally designed for use with even-toed ungulates. In the case of odd-toed ungulates with, for example, three hooves, a suitably modified fastening shaft can of course be used, from the trunk of which as many arms branch off as claws are to be enclosed.

At least one of the arms of a fastening shaft structured in a branched manner, for example a Y-shaped fastening shaft, can comprise an attachment region for the connection to the shoe base. According to one embodiment, the shoe base can therefore be arranged on one of the arms which is assigned to the claw to which the shoe base is to be affixed.

Depending on the field of application, however, it is also possible that several shoe bases are present which are arranged on several or all arms of a branched fastening shaft. An animal shoe with a Y-shaped or branched fastening shaft, in which one shoe base is arranged on each arm, can be used in a preventive manner. The stable floor might be very rough. This leads to massive horn abrasion on the claw sole of even-toed ungulates. Massive horn abrasion can lead to lame animals. This can be prevented by this embodiment in which a shoe base can be attached to all claws. The aim is to protect the claw horn. This embodiment also protects against particularly aggressive floors and heavy loads. In addition, the animals are in this embodiment placed almost on a soft ground, the shoe base, due to the damping properties of the shoe bases. Due to a mycotoxin uptake via the feed or the spread of endotoxins in the bloodstream, animals, especially cows, can show generalized inflammatory symptoms. These inflammations are also found in all limbs and therefore also in the suspension apparatus of the claws. The result is that the animals are in pain and walk lame. Such pain can be alleviated by this embodiment with a shoe base for every claw. According to one embodiment, several individual shoe bases with fastening portions can be attached in a preventive manner to the individual claws of a limb which are attached to the claw horn.

In the case of even-toed ungulates with a claw disorder, usually only one of the two claws is affected. The injured claw is to be relieved in that the shoe base is affixed to the healthy claw. At the same time, it is endeavored to protect the injured claw and/or the applied dressing against dirt and unwanted external influences. This can be achieved in a simple manner by way of a Y-shaped fastening shaft, on the one arm of which a shoe base according to the invention is arranged. The arm of the fastening shaft, on which the shoe base is not arranged, is associated with the injured claw and can there provide the function of a jacket for protection against external influences. In one further embodiment, the arm associated with the injured claw can be closed at its distal end and therefore provide a capsule in which the injured claw can be received in a manner enclosed on all sides. For better wound healing, an active substance or liquid reservoir and/or a liquid adsorbent can also be accommodated on the arm associated with the injured claw and can influence the healing process.

The limbs of animals, such as cows, are adapted to soft and resilient grounds. Soft soils enable the cows to distribute the load pressure to the largest possible claw surface and to the weight-bearing horny portions. In typical dairy cattle stables, the animals stand and walk on hard-surfaced or slatted floors, weight forces are concentrated on small claw areas since no adaptation can take place on such grounds. When using known block systems, it is not taken into consideration that the healthy claw needs to support the entire weight of a limb. The shoe base of the invention is instrumental in the relief of the injured animal foot. To increase the wearing comfort of the animal shoe, the shoe base can be made of a material that has a damping effect. With damping, which is not possible with a claw block, for example, the pressure forces acting on the animal foot are reduced. The damping shoe base enables a natural sequence of motion and physiological force transmission to the supporting parts of the animal extremities. The damping shoe is also designed to carry the weight of both claws, i.e. twice the weight, and therefore to dampen twice the weight. The shoe base can be designed, in particular in an embodiment for even-toed ungulates, to absorb twice the weight of what rests on the respective animal foot during a natural sequence of motion. The shoe base can, in particular, form a support of the body's own damping pad and thus maintain the physiological sequence of motion and the weight distribution of the animal feet. Overload caused by the increased load on the healthy claw can be avoided by the damping properties of the shoe base.

According to one embodiment, the material of the insole of the shoe base is softer than the material of the outsole. A softly formed insole serves to dampen and protect against rubbing and is able to adapt to the anatomy specific to the animal. It is specifically designed to compensate for unevenness, for example, caused by an irregular claw sole. Possibilities to configure the insole accordingly are, for example, forming the insole from a gel layer or a foam layer or the inclusion of a gel layer or a foam layer in the insole, respectively. The material of the insole can be movable or deformable relative to the material of the outsole. The outsole of this embodiment is not rigidly joined to the insole, allowing the animal foot to replicate the natural rotation and spreading of the claws/toes during the foot placement process.

Particularly preferably, the insole can be formed from open-cell or open-pored material, for example, open-cell plastic material or other open-cell foam, especially in the sole region which comes into contact with the animal foot. Such open-cell material, for example, open-cell plastic foam, compensates for unevenness. Unevenness on a claw sole can thus be compensated reliably, which no longer necessitates previously needed claw trimming, as is required when using the claw blocks known from prior art.

The outsole of the shoe base preferably also has damping properties and thereby supports the natural damping properties of the digital cushion, which is present in the animal foot as fatty tissue and serves to support the pedal bone.

According to one embodiment, the outsole can be formed from closed-pored or closed-cell material, for example, closed-cell plastic material or other closed-cell foam. It has been found that such closed-cell material, for example, closed-cell plastic foam, has the desired damping properties and at the same time provides a barrier which prevents soiling or moisture from penetrating through the outsole up to the sole surface of the shoe base. Despite adequate damping properties, such closed-cell polymers are typically sufficiently strong to absorb the initial foot placement pressure and support the healthy claw in bearing the extra load.

The tread surface of the outsole can be provided with anti-slip elements which ensure safe foot placement of the animal even on slippery surfaces. For this purpose, the tread surface or a part of the tread surface can be provided, for example, with a tread pattern.

In one further embodiment which is advantageous, for example, for even-toed ungulates, the outsole and/or the insole can be reinforced with a support zone (or reinforcement zone). The reinforcement zone can be formed in the regions of the outsole or insole, respectively, which corresponds to the bearing edge of the claw, i.e. be located in regions upon which the bearing edge of the animal claw rests. With a reinforcement zone, the sole in the region which is associated with the bearing edge of the claw is specially worked out and adapted to the physiological natural weight distribution of the animals. In the reinforcement zone, the outsole or insole, respectively, can be denser, i.e. be harder. As a result, it is achieved that weight-bearing claw portions bear down on a harder but preferably still damping region of the sole. Claw portions requiring gentle treatment can be underlaid by the soft and protective area of the sole. The outsole can be made of a hard component that is harder than the insole, which can be made of a soft component. It is also possible to manufacture the reinforcement zone of a sole from a hard component and the remainder of the sole (outsole and/or insole) from a comparatively softer soft component.

Alternatively or additionally, the outsole can have as a reinforcement zone a supporting tread pattern projecting from the tread surface, preferably in the edge regions of its tread. The configuration of such a tread pattern is specifically intended for ungulates that do not set down their hooves or claws uniformly, respectively. Or for animals whose body weight is increasingly carried only by certain parts of the extremity, as for example, with cattle, where the supporting part of the claw is the so-called wall edge. Due to the configuration of the outsole with a profiled tread surface, which is reinforced in the region of the bearing edge, the weight of the cow is focused on the physiological portions of the claw. The shoe base supports the natural movement and the physiological force transmission of the corresponding animal limb, which avoids undesirable overloading of normally not excessively loaded parts, for example, of a central claw surface, due to an unnatural sequence of motion.

The shoe base, in particular its outsole, can therefore comprise a sole-bearing edge. The sole-bearing edge is the region that is reinforced by a support zone, which can be achieved, e.g. by material projecting from the sole or material having a greater strength as compared to other regions of the sole. Preferably, the hardness of the sole in the support zone corresponds to the hardness of the horny part of a claw, and takes into account the double load of additionally supporting the sick claw.

The support zone can be disposed in the regions of the shoe base that are associated with the claw portion of the animal foot. For example, the reinforced support zone can be formed at edge regions of the shoe sole. The comparatively softer and more elastic central region of the shoe base or the sole is then less loaded. This protects the central portions of the claw from overload.

The material of the support zone can absorb the load during the foot placement phase, in which high loads arise, whereas the more elastic regions distribute the forces evenly throughout the shoe base during the support phase of the claw and provide the limbs with a level support for safe tread. In this embodiment, the shoe base can correspond in hardness and elasticity to the claw portion of the digital cushion of a claw. As a result, the natural sequence of motion of the animals is supported by the animal shoe according to the invention. In particular, the digital cushion can fulfill its function as a circulation cushion, which ensures two-phase blood circulation above the claw when loaded and unloaded. The pumping function of the digital cushion and the physiological foot placement are thus maintained.

According to one further embodiment, the shoe base can be constructed in two layers and comprise an outsole component and an insole component. The outsole component and the insole component can be slidable relative to each other. The outsole component and the insole component can also be fixedly connected to one another, for example, be welded together. The welding can be done, for example, by lamination. The boundary layer between the insole component and the outsole component is preferably planar, so that a plane surface is given for the transmission of force.

Exemplary materials from which the shoe base, in particular, its outsole component and/or its insole component can be made, are foamable substances, for example plastic materials such as, inter alia, polylactic acid, polyethylene or polyethylene terephthalate, or also rubber, gels and silicones. The outsole component and the insole component can be made of different or the same materials. The material of the shoe base can also be degradable petrochemically and/or biologically.

The animal shoe according to the invention can consist of a multicomponent material employing hard and soft components. The insole can be formed from a soft component and the outsole from a hard component. It is also possible to form a defined region within the outsole and/or the insole from a hard component and other defined regions from a soft component. For example, a support zone can be formed from a hard component.

Material combinations of technical thermoplastics (hard component) and thermoplastic elastomers (soft component) are possible. These components can be mechanically anchored together (breakthrough, undercut) and/or joined by adhesive force (cohesion, adhesion). With adhesion bonding, the surface of the hard component can be softened by injecting a soft component over it so that diffusion of molecules from the boundary layer can take place.

According to one embodiment, the insole component and/or the outsole component consists of extruded plastic material, for example polyethylene or polyethylene terephthalate. If the two sole components consist of the same material, then coextrusion with simultaneous joining of the two components is possible in a particularly simple manner.

The production of the insole made of plastic material or as foam padding also makes it possible to selectively remove individual regions of the cushioning foam in a simple manner. In this way, a sole surface can be provided which is customized to a lesion of the injured claw such that the lesion is associated with the recess of the sole material.

According to one embodiment, the shoe base can be made of the same material as the fastening shaft, which enables the production in one casting process or simplifies joining the shoe base and the fastening shaft, respectively. The animal shoe according to the invention can be produced using 3D printing technology.

It is characteristic of even-toed ungulates, especially cattle, that with their front claws, they tread down first with the cranial toe, i.e. the one facing the head, with the hind claws, on the other hand, they tread down first with the caudal ball or bulb, i.e. the one facing the tail. In order to take account of this uneven force and pressure distribution, the tread surface of the outsole according to a further embodiment can be bent upwardly at its front caudal or at its cranial end, respectively, in the direction of the insole. This curvature increases the claw surface, which serves as a force-transmitting surface when placing the foot and running. As a result, the surface which absorbs the initially large reaction forces is increased. The tread surface is configured in such a way that the animal is able to place the foot over the upwardly bent portion of the tread surface in a particularly effective manner. According to a particularly advantageous embodiment, the tread surface of the outsole is bent upwardly both at its forward caudal end as well as at its cranial posterior end. The same animal shoe can be used for the front and the rear extremities of the same side. In this embodiment, it is therefore only necessary to provide two different types of animal shoes, one model for the left and one for the right limbs of the animal extremities. According to one embodiment, the thickness of the shoe base tapers. For this purpose, the insole component and/or the outsole component can be tapered to realize the desired curvature in this region. Alternatively, the outsole can be shaped to match.

According to one further embodiment, the animal shoe according to the invention can comprise a ball protection. A ball protection is understood to be a cushion that protectively covers a soft tissue portion and avoids unwanted irritation. With even-toed ungulates such as cattle, in particular the digital cushion which protects the pedal bone when treading on the ground during the loading phase must be relieved. The deformation of the natural digital cushion is important to absorb and dampen load forces in the natural sequence of motion. The blood circulation in the claw is maintained by the loading and unloading phases of the digital cushion, so that unwanted irritation thereof is to be prevented to the extent possible, which can be achieved according to the invention by a ball protection.

According to one embodiment, the insole can form the ball protection. For this purpose, the insole can be thickened, for example, in its regions abutting against the ball or be designed to be particularly dampening. With even-toed ungulates, the digital cushion is located unprotected in the heel area. If the shoe base is configured to be longer than the length of the foot of the animal, measured from the tip of the foot to the “heel” or ball, then the shape of the shoe base is adapted such that the ball protection is slightly curved and abuts snugly against the ball. According to this embodiment, the outsole can also abut against the digital cushion, separated by the insole. One embodiment is possible in which the insole forms the digital cushion, in that the caudal part of the insole projects beyond the caudal end of the outsole. The protrusion forms the ball protection in this embodiment. According to one further embodiment, the ball protection forms a bedding for the fastening shaft, whereby it is prevented that the fastening shaft abuts directly against sensitive tissue parts in an undesired manner.

The animal shoe according to the invention can in principle be used for any animal species. Although it is particularly suitable for even-toed ungulates, especially cattle, it is nevertheless equally usable for other even-toed ungulates, such as pigs, goats or sheep. The use with pigs is advantageous because they cannot be fitted the commercially available claw blocks due to their anatomy. Even with odd-toed ungulates or small animals, the animal shoe according to the invention can be used in an advantageous orthopedic manner to relieve extremities or injured animal feet.

The present invention further relates to a shoe base for an animal shoe, in particular for an orthopedic shoe for animal feet for the relief of lame even-toed ungulates, which according to the invention comprises an outsole and an insole that is disposed opposite to the outsole, where the outsole is formed from closed-cell material and the insole is formed from open-cell material. The outsole and the insole can advantageously be configured as described above with regard to the animal shoe according to the invention.

The present invention further comprises a kit according to the invention for an animal shoe, in particular for an orthopedic shoe for the relief of lame even-toed ungulate, comprising a shoe base according to the invention and a fastening shaft that can be customized/adjusted accurately to the animal foot, where said fastening shaft comprises a fastening portion for affixing the shoe base to the animal foot and an attachment region for the connection to the shoe base. The shoe base and the fastening shaft can advantageously be configured as described above with regard to the animal shoe according to the invention.

The invention shall be explained hereafter in more detail by way of example using advantageous embodiments with reference to the drawings. The feature combinations illustrated in the embodiments by way of example can respectively be supplemented in terms of the above explanations by other features for a particular case of application. Individual features can also be omitted in the embodiments described in accordance with the above explanations if the effect of this feature is irrelevant for a specific case of application. The same reference numerals in the drawings are always used for elements of the same function and/or the same structure,

where

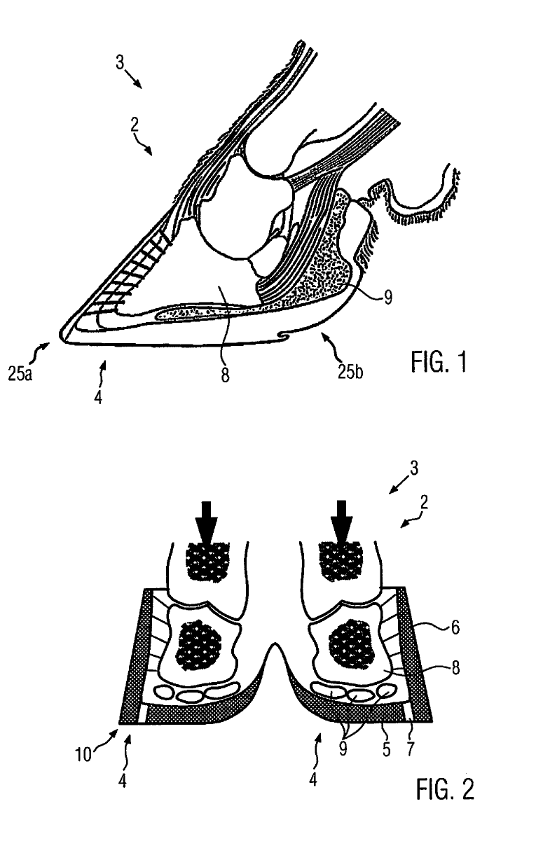

FIG. 1 shows an anatomical side view of an animal foot using the example of a cattle claw;

FIG. 2 shows an anatomical view of a cow claw from behind;

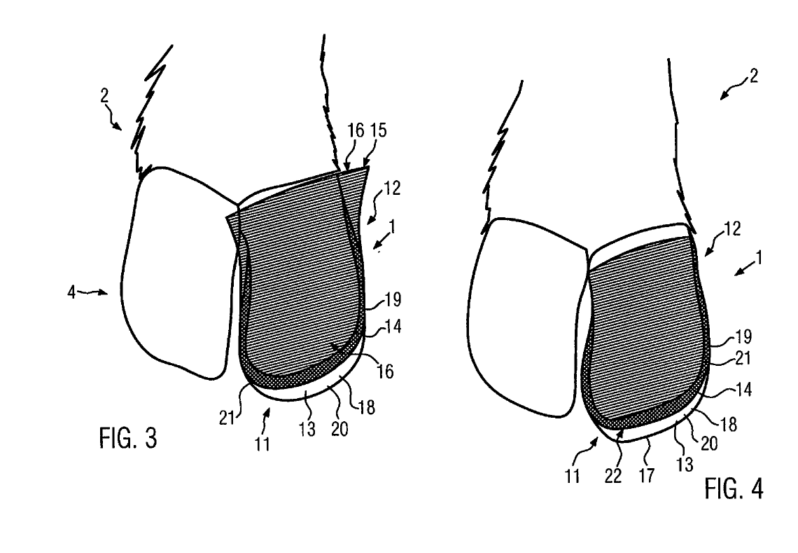

FIG. 3 shows a perspective view of an animal shoe according to the invention in a donned but non-affixed state according to a first embodiment;

FIG. 4 shows the first embodiment of the animal shoe according to the invention of FIG. 3 in its affixed configuration;

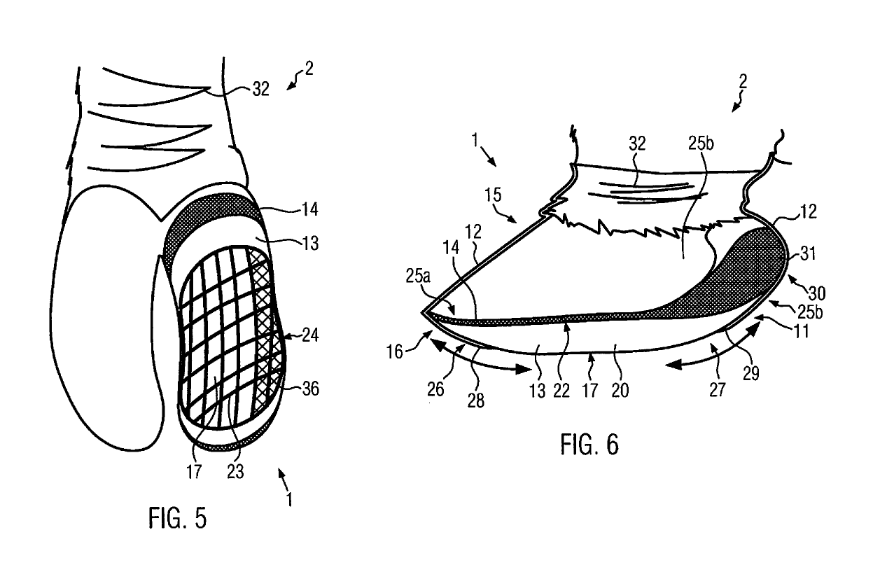

FIG. 5 shows a top view onto an animal shoe according to another embodiment viewed from below;

FIG. 6 shows a schematic side view of the animal shoe of the second embodiment of FIG. 5 in its affixed configuration in a perspective side view;

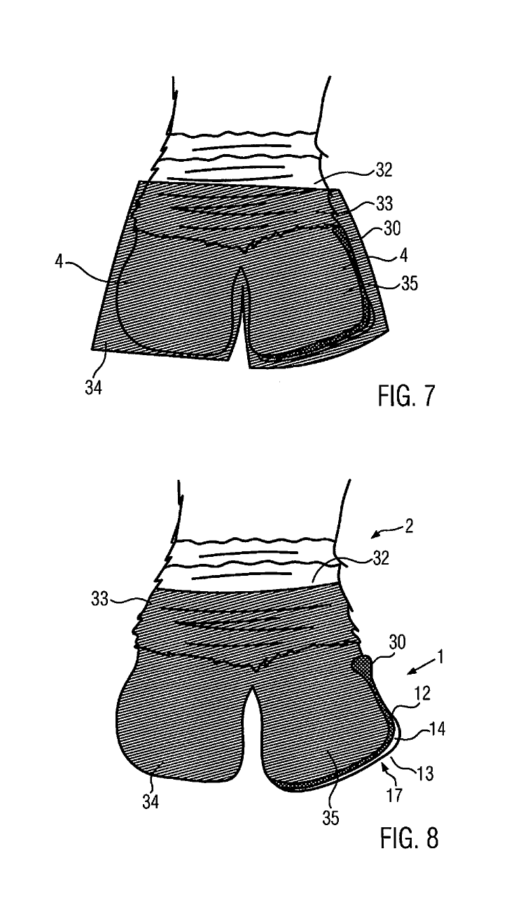

FIG. 7 shows a perspective view of an animal shoe according to the invention in a donned but non-affixed state according to a third embodiment; and

FIG. 8 shows the embodiment of the animal shoe according to the invention of FIG. 7 in its affixed configuration.

Various exemplary embodiments of the present invention are shown hereinafter using the example of an animal shoe 1 for an animal foot 2 of an even-toed ungulate 3, for example cattle.

Before the individual embodiments of the invention are explained in more detail with reference to the accompanying figures, the structure of the distal limbs, i.e. the animal feet 2 of cattle, shall first be discussed briefly with reference to FIGS. 1 and 2.

Cattle are so-called even-toed ungulates 3. Two toes which are referred to as claws 4 are disposed on each of their limbs or animal feet 2. They are referred to as the inner claw and the outer claw. The claw consists of a horny capsule comprising a sole horn 5 and a wall horn 6, where the point at which sole horn 5 and wall horn 6 meet is designated as white line 7. The bone, which is suspended in the horny capsule, so-called pedal bone 8, has digital cushion 9 as a natural cushioning protection which consists of the ball underlying dermis with fatty tissue cushions.

Digital cushion 9 protects pedal bone 8 when treading on the ground in the loading phase. Due to its share of fatty tissue, it deforms under load, which deformation is essential in order to absorb and cushion pressure loads from the body weight, which are symbolized in FIG. 2 by arrows pointing downwardly.

During the sequence of motion, the outer claw first treads on the ground because the associated bone projection 10 is longer by a few millimeters. Thereafter, the weight is first largely transferred to the inner claw, until it is finally distributed evenly onto both claws 4.

After this brief introduction to the anatomy of the limbs of cattle as examples of even-toed ungulates, a first embodiment of an animal shoe 1 according to the invention shall be explained in more detail below with reference to FIGS. 3 and 4.

Animal shoe 1 of the first embodiment according to the invention represents an orthopedic shoe for animal foot 2 for the relief of lame even-toed ungulates 3.

The animal shoe comprises a shoe base 11 and a fastening shaft 12 for affixing shoe base 11 to animal foot 2.

Shoe base 11 comprises an outsole 13 and an insole 14 that is disposed opposite to outsole 13. Outsole 13 is the part of shoe base 11 which faces away from animal foot 2 and which comes into contact with the ground. Insole 14 is the part of shoe base 11 which comes into contact with animal foot 2.

Fastening shaft 12 in the illustrated embodiment is configured hose-like, similar to a knee sock or stocking and can be slipped over the healthy claw 4 in a simple manner to raise healthy claw 4 by attaching shoe base 11 (which in the embodiment shown can also be referred to as a claw block) and to relieve the injured claw.

Fastening shaft 12 comprises a fastening portion 15 for affixing shoe base 11 to claw 4 of animal foot 2. Fastening portion 15 in the embodiment shown by way of example is disposed in the region of fastening shaft 12 that is disposed opposite to shoe base 11. It has an entry opening 16 through which claw 4 can be inserted into the interior of fastening shaft 12.

At the end opposite to fastening portion 15, fastening shaft 12 comprises an attachment region 16 for the connection to shoe base 11. This attachment region 16 can be connected, for example welded, to shoe base 11 preferably by way of lamination, so that animal shoe 1 according to the invention can be handled as one piece with its fastening shaft 12 and its shoe base 11.

In the embodiment shown, fastening shaft 12 is formed from shrinkable material, for example a shrink hose, such as a heat shrink hose. Such material is characterized by the fact that it shrinks when heated, i.e. it contracts and is thereby fitted accurately to the animal foot. While the dimensions of the interior of the animal shoe enclosed by fastening shaft 12 before shrinkage are dimensioned such that the part of animal foot 2 to be accommodated, a claw 4 in the embodiment shown, can be placed thereinto (FIG. 3), fastening shaft 12 abuts with a precise fit against the claw 4 after fixation (see FIG. 4), i.e., in a positive-fit manner, thereby affixing animal shoe 1 according to the invention to animal foot 2.

The embodiment of animal shoe 1 according to the invention with its fastening shaft 12 enables a secure and reliable fit of animal shoe 1 on animal foot 2, without having to use adhesives which often contain harmful ingredients and which are problematic in their handling.

Shoe base 11, which can be made, for example, of one or more extruded plastic materials, such as plastic foams, supports the fatty tissue in the digital cushion 9 and provides better damping which lessens the pressure forces acting on claw 4.

In the embodiment shown, the material of insole 14 is softer than the material of outsole 13. The softer layer of insole 14 serves to protect against rubbing on the sole of animal foot 2 and additionally turns insole 14 into an adaptive layer. This adaptability enables animal shoe 1 according to the invention to adapt to the animal-specific anatomy and, for example, to compensate for unevenness caused by the irregular claw sole.

Outsole 13 in the embodiment shown also has damping properties which support the damping properties of digital cushion 9. Tread surface 17 of outsole 13 is the contact surface of animal shoe 1 to the ground. A higher degree of strength as compared to insole 14 is more advantageous in that it makes outsole 13 more resistant to wear.

In one embodiment, outsole 13 can be formed from closed-cell foam 18 and insole 14 from open-cell foam 19. Open-cell foam 19, for example open-cell plastic foam, can simultaneously serve as a moisture protection because unwanted fluid can penetrate into the cells. At the same time, closed-cell foam 18 prevents impurities from undesirably reaching the interior of animal shoe 1 via shoe base 11.

In the exemplary embodiment of animal shoe 1 shown in FIGS. 3 and 4, shoe base 11 is structured having two layers. It comprises an outsole component 20, which constitutes a first damping element, and an insole component 21, which constitutes a second damping element. Outsole component 20 and insole component 21 are joined to each other in the exemplary embodiment of shoe base 11. For this purpose, they are welded to each other at their boundary surface 22, which in the embodiment shown is configured to be planar on account of the planar surfaces of sole components 20, 21. They can be joined to each other, for example, by way of lamination.

A second embodiment of an animal shoe 1 according to the invention shall be explained hereafter in more detail with reference to FIGS. 5 and 6. Where only the differences/peculiarities of animal shoe 1 according to the invention of the second embodiment shall be described in detail in comparison to the animal shoe of the first embodiment of FIGS. 3 and 4 and further details of animal shoe 1 according to the invention which are not readily apparent from FIGS. 3 and 4 shall be described.

It is evident from FIG. 6 that fastening shaft 12 does not completely enclose shoe base 11, but that a large portion of tread surface 17 of outsole 13 is exposed. In particular, the portion of tread surface 17 which is provided with a tread pattern 23 in the embodiment shown in FIGS. 5 and 6 is not covered by fastening shaft 12.

On the one hand, tread 23 serves as a better support and additionally compensates for irregularities in the ground. A tread 23 on tread surface 17 can also be configured in such a way that outsole 13 comprises a reinforcement zone 36 on its bearing or wall edge 24. The outsole in reinforcement zone 36 can either be hardened, i.e. harder than the remainder of outsole 13, or can protrude out from tread surface 17. In this way, the geometry of outsole 13 is adapted to the anatomy of the claw of a cow. Animal shoe 1 according to the invention therefore simulates the natural supporting components and allows for the natural sequence of motion of cattle. Reinforcement zone 36 supports the body's own damping cushion and serves to maintain a physiological sequence of motion, as well as the distribution of weight of the animal feet.

Animal shoe 1 of the second embodiment according to the invention also accounts for another feature of the sequence of motion, specifically of cattle, but which can also be found with other animals, especially even-toed ungulates.

The front and rear limbs differ in terms of the foot placement phases of the cattle. The reason for this is the different position of these limbs. The front hooves first tread down with the claw or toe 25a facing the cranial direction. With the rear limbs, by contrast, the cattle first treads down with foot ball or bulb 25b at the caudal end.

In consideration of the different foot placement phase, tread surface 17 is bent upwardly at its front caudal end 27. Tread surface 17 is likewise bent upwardly at its cranial end 26, as can be seen particularly well in FIG. 6. Curves 28 and 29, as well as curves 26 at the cranial and 27 at the caudal end allow the animal, when using one and the same animal shoe 1, to tread down with both its front and rear limbs on a larger force-transmitting surface, namely curves 28, 29. As a result, the animals can roll from one end of the tread surface 17 to another in a pressure-optimized manner, according to their natural sequence of motion, and distribute the weight evenly over the entire claw, which is indicated by the curved arrows in FIG. 6. The weight distribution corresponds to the physiological distribution when walking on a soft surface.

In the embodiment shown in FIG. 6, curves 28, 29 are formed in that the thickness of shoe base 11 tapers towards cranial end 26 and caudal end 27. In the embodiment shown, specifically the thickness of outsole 13 tapers, which can have a thickness, for example, at the center where it is thickest, in the range of 10-45 mm.

FIG. 6 shows that a flat boundary surface 22 is formed between outsole component 20 and insole component 21 of the illustrated embodiment, which enables good transmission of forces between the two components 20, 21. It can also be seen that insole 14 with exemplary 3-15 mm in the embodiment illustrated is thinner than the thickness of outsole 13, with one exception, which shall now be discussed in greater detail.

Animal shoe 1 according to the invention of the second embodiment has a bulb or ball protection 30. Ball protection 30 covers the sensitive tissue part of the digital cushion 9 not surrounded by a horny layer which is located at the caudal end of animal foot 2. Ball protection 30 protects the region of the bulb and forms a bedding 31 for fastening shaft 12, so that the latter does not directly contact digital cushion 30. In this way, ball protection 30 protects, in particular, sensitive parts of animal foot 2 that are arranged inside animal shoe 1 according to the invention.

In the exemplary embodiment of animal shoe 1 according to the invention, insole 14 forms ball protection 30. For this purpose, insole 14 is thickened in the region of ball protection 30 and additionally protrudes beyond outsole 13 at caudal end 27. In animal shoe 1 of the exemplary embodiment shown in FIGS. 5 and 6, it is apparent that the length of animal shoe 1 measured from its tip at cranial end 26 to its caudal end 27 is longer than the foot length of the animal. This makes it possible to apply the portion of animal shoe 1 located at caudal end 27 to the digital cushion 9 as a ball protection 30 between fastening shaft 12 and the heel of the animal foot. Under certain circumstances, outsole 13 also encloses ball protection 30 formed by insole 14 for protection against soiling.

In order to protect further sensitive parts of animal foot 2, which can come into direct contact with the fastening shaft, insole 14 can be continued according to the invention on soft horn locations, for example, between the claws.

Finally, a third embodiment of an animal shoe 1 according to the invention shall be discussed with reference to FIGS. 7 and 8.

Shoe base 11 of animal shoe 1 of the third exemplary embodiment corresponds to the shoe base of one of the preceding embodiments.

Animal shoe 1 of the third embodiment comprises a fastening shaft 12 which is configured having a Y-shape. Due to the Y-shape, fastening shaft 12 comprises a trunk 33 which is arranged substantially in the upper region or above the claws and, for example, can cover and/or affix dressing material 32 at least in part. The trunk can include a fastening portion 15. Fastening shaft 12 of the Y-shaped configuration further comprises two fastening arms 34, 35 branching off from trunk 33, in each of which a claw 4 can be accommodated.

With the specially configured fastening shaft 12 of the embodiment of FIGS. 7 and 8, it is possible to affix shoe base 11 onto the healthy claw, as described in the preceding embodiments. At the same time, the injured claw can be accommodated in one of fastening arms 34. This accommodation enables protecting the injured claw against external influences. For example, the injured claw can be bandaged and the bandage be accommodated in fastening arm 34 and affixed by the latter. In this case, it is possible to completely close fastening arm 34, in which the injured claw is accommodated, at its end facing the claw tip, so that this fastening arm 34 completely encapsulates the injured claw and protects it against soiling or other undesired external influences.

### REFERENCE NUMERALS

1 animal shoe
2 animal foot
3 even-toed ungulate
4 claws
5 sole horn
6 wall horn
7 white line
8 pedal bone
9 digital cushion
10 bone projection
11 shoe base
12 fastening shaft
13 outsole
14 insole
15 fastening portion
16 entry opening
17 tread surface
18 closed-cell foam
19 open-cell foam
20 outsole component
21 insole component
22 bordering surface
23 tread pattern
24 bearing edge
25a tip of the foot
25b ball
26 cranial end
27 caudal end
28 curvature
29 curvature
30 bulb protection
31 bedding
32 dressing
33 trunk
34 fastening arm
35 fastening arm
36 reinforcement zone

1-15. (canceled)

16. Animal shoe, in particular an orthopedic shoe for animal feet for the relief of lame even-toed ungulates, comprising a shoe base which has an outsole and an insole that is disposed opposite to said outsole, and a fastening shaft which can be customized accurately to said animal foot and affixed to said animal foot.

17. Animal shoe according to claim 16, characterized in that said fastening shaft is made of shrinkable material.

18. Animal shoe according to claim 16, characterized in that said fastening shaft is connected to said shoe base such that it can be handled as one piece.

19. Animal shoe according to claim 18, characterized in that said fastening shaft and said shoe base are welded together, wherein they are preferably connected to each other by lamination.

20. Animal shoe according to claim 16, characterized in that said fastening shaft is configured to have a Y-shape.

21. Animal shoe according to claim 16, characterized in that the material of said insole is softer than the material of said outsole.

22. Animal shoe according to claim 16, characterized in that said outsole is formed from closed-cell material and/or said insole is formed from open-cell material.

23. Animal shoe according to claim 16, characterized in that a tread surface of said shoe base at its front cranial end and/or at its rear caudal end is bent upwardly in the direction of said insole.

24. Animal shoe according to claim 16, characterized in that said shoe base is constructed having two layers and comprises an outsole component and an insole component.

25. Animal shoe according to claim 24, characterized in that said outsole component and said insole component are welded together, wherein they are preferably connected to each other by lamination.

26. Animal shoe according to claim 16, characterized in that said outsole and/or said insole comprises a reinforcement zone.

27. Animal shoe according to claim 16, characterized by a ball protection.

28. Animal shoe according to claim 27, characterized in that said ball protection forms a bedding for said fastening shaft.

29. Shoe base for an animal shoe, in particular for an orthopedic shoe for animal feet for the relief of lame even-toed ungulates, where said shoe base comprises an outsole formed from closed-cell material and an insole that is disposed opposite to said outsole and formed from open-cell material.

30. Kit for an animal shoe, in particular an orthopedic shoe for animal feet for the relief of lame even-toed ungulates, comprising:
a shoe base according to claim 29; and
a fastening shaft which can be customized accurately to said animal foot and comprises a fastening portion for affixing to said animal foot and an attachment region for the connection to said shoe base.
